(19) United States
(12) Patent Application Publication
(10) Pub. No.: US 2004/0060242 A1
(43) Pub. Date: Apr. 1, 2004

(54) Weatherstrip forming a slideway for a motor vehicle window

(76) Inventors: Laurent Coldre, La Neuville Sur Essone (FR); Stephane Drivon, Chalette Sur Loing (FR)

Correspondence Address: CLARK & BRODY, Suite 600, 1750 K Street, NW, Washington, DC, 20006, US

(21) Appl. No.: 10/629,648

(22) Filed: Jul. 30, 2003

(30) Foreign Application Priority Data
Aug. 2, 2002 (FR) 0209872

(51) Int. Cl. E06B 7/16

(52) U.S. Cl. 49/490.1; 49/495.1; 49/475.1

(57) ABSTRACT

The invention provides a weatherstrip forming a slideway for a motor vehicle window, the strip comprising at least a fixing portion in the form of a channel-section clip suitable for engaging on a flange of the frame of a window opening of the vehicle, and a portion for supporting sealing lips that are suitable for coming into sliding contact with a sliding window pane, wherein the fixing portion and the portion for supporting sealing lips are both made of rigid thermoplastic material without any reinforcing means being present.

The invention relates to a weatherstrip forming a slideway for a motor vehicle window, it being understood that the invention is applicable to any type of motor vehicle whether for use on the road (private cars, utility vehicles, buses, trucks, . . . ), or for use on rail or on water, for example.

### BACKGROUND OF THE INVENTION

In the road vehicle field, for example, a weatherstrip is mounted on the frame of a window bay in a door, said bay being suitable for being open, partially open, or closed by means of a window pane that slides under manual and/or automatic control. Such a weatherstrip comprises a wiper which is fixed to the bottom portion of the frame around the opening, and slideways which are fixed to the top and side portions of said frame.

At present, there exist two major families of slideways, namely: non-reinforced flexible slideways which are fitted in channel-section housings formed in the framework of the door; and reinforced slideways which are fitted on flanges of the door framework, it being understood that this second family comprises both single-flange slideways and hidden-frame slideways.

A prior art reinforced slideway comprises at least one fixing portion in the form of a channel-section clip that is engaged on the door frame and that is implemented by means of a metal strength member embedded in an elastomer material such as rubber, together with a sealing lip support portion into which the reinforcing strength member may extend, depending on the type of slideway.

Such slideways offer satisfactory performance, however the use of metal reinforcement nevertheless presents a certain number of drawbacks such as the risk of corrosion, the lack of natural adhesion between elastomers and metals, electrical and thermal conductivity, high density, and above all such slideways are heavy and expensive to make.

### OBJECTS AND SUMMARY OF THE INVENTION

An object of the invention is to mitigate the above-mentioned drawbacks and to propose slideways of design that is optimized both in terms of weight and in terms of cost, and having performance that is at least comparable with the performance of prior art slideways.

To this end, the invention provides a weatherstrip forming a slideway for a motor vehicle window, the strip comprising at least a fixing portion in the form of a channel-section clip suitable for engaging on a flange of the frame of a window opening in the vehicle, and a support portion for supporting sealing lips which are suitable for coming into sliding contact with a sliding window pane, wherein the fixing portion is made from a rigid thermoplastic material without any reinforcing means being present.

Furthermore, the sealing lip support portion may be made of a thermoplastic material having a bending modulus that is much smaller than that of the thermoplastic material used for the fixing portion of the weatherstrip.

Advantageously, a hinge is formed between the fixing portion and the sealing lip support portion, said hinge possibly being made by reducing the thickness of the material or by using a material that is more flexible than the material used for making the above-specified portions.

In general, a weatherstrip of the invention can equally well be used for forming a single-flange slideway or for forming a hidden-frame type slideway.

### BRIEF DESCRIPTION OF THE DRAWINGS

Other advantages, characteristics, and details of the invention appear from the following additional description made with reference to the accompanying drawings that are given purely by way of example, and in which:

FIGS. 1 to 3 are right section views of weatherstrips for illustrating the prior art mentioned in the introduction;

FIGS. 4 and 4a are two right section views showing a weatherstrip constituting a first embodiment of the invention; and

FIG. 5 is a right section view showing a second embodiment of the invention.

### MORE DETAILED DESCRIPTION

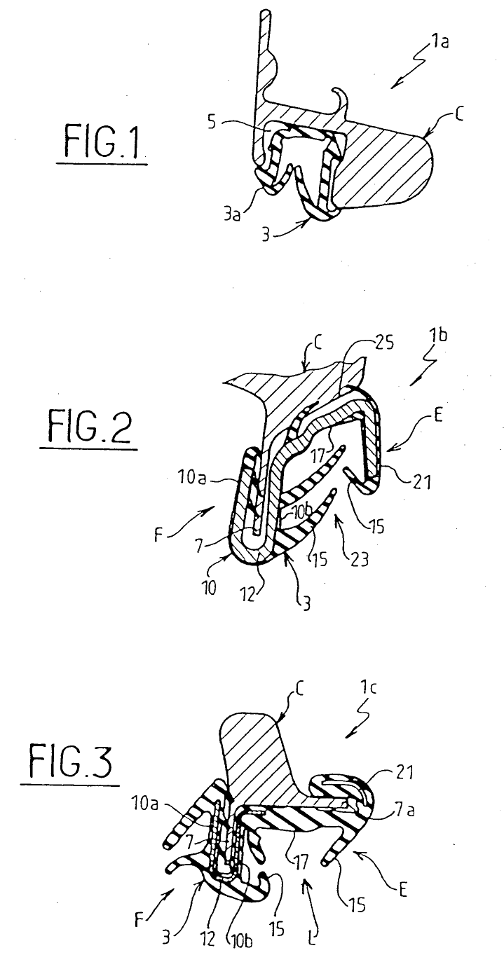

The weatherstrips shown in FIGS. 1 to 3 are representative of the prior art mentioned in the introduction. The weatherstrip 1a in FIG. 1 forms a flexible slideway 3 of the non-reinforced type which is received in a channel-section housing 5 formed in the framework C of a motor vehicle door, for example. The slideway 3 is represented solely by a top segment 3a whose right section is likewise a channel section. In general, such a slideway is made of an elastomer material such as rubber and does not present reinforcing means.

In contrast, the weatherstrips 1b and 1c of FIGS. 2 and 3 form reinforced slideways 3 which are engaged on a flange 7 of the framework C of a motor vehicle door. For this purpose, these slideways 3 present in particular a fixing portion F in the form of a clip 10 having two jaws 10a and 10b which hold the flange 7. Each clip 3 is made from a strength member 12, usually made of metal, which is embedded in an elastomer material such as rubber.

The reinforced slideway 3 of FIG. 2 is of the single-flange type and it also presents a support portion E for supporting sealing lips 15, at least some of which come into sliding contact with a moving window pane (not shown). More precisely, this support portion E presents an intermediate web 17 which extends the jaw 10b of the clip 10 and which extends substantially perpendicularly to the flange 7, followed by an end branch 21 facing the clip 10 so as to define a channel-section housing 23 in which a sliding pane can engage freely. The intermediate web 17 is designed to bear against a portion 25 of the sheet metal constituting the framework C of the door. The reinforcing strength member 12 constituting the clip 10 thus extends into the web 17 and the branch 21. The entire weatherstrip 1b is covered in a flexible elastomer material such as rubber.

The reinforced slideway 3 shown in FIG. 3 is of the hidden frame type and it likewise presents a support portion E for supporting sealing lips 15 at least some of which are to make sliding contact with a moving pane (not shown). More precisely, as for the slideway of FIG. 2, this support portion E presents an intermediate web 17 which extends the jaw 10b of the clip 10 and which extends substantially perpendicularly to the flange 7, but the end branch 21 is itself folded round a flange 7a of the door frame C. The reinforcing strength member 12 of the clip 10 may possibly extend over a fraction only of the intermediate web 17. The entire weatherstrip 1c is made of flexible elastomer material such as rubber.

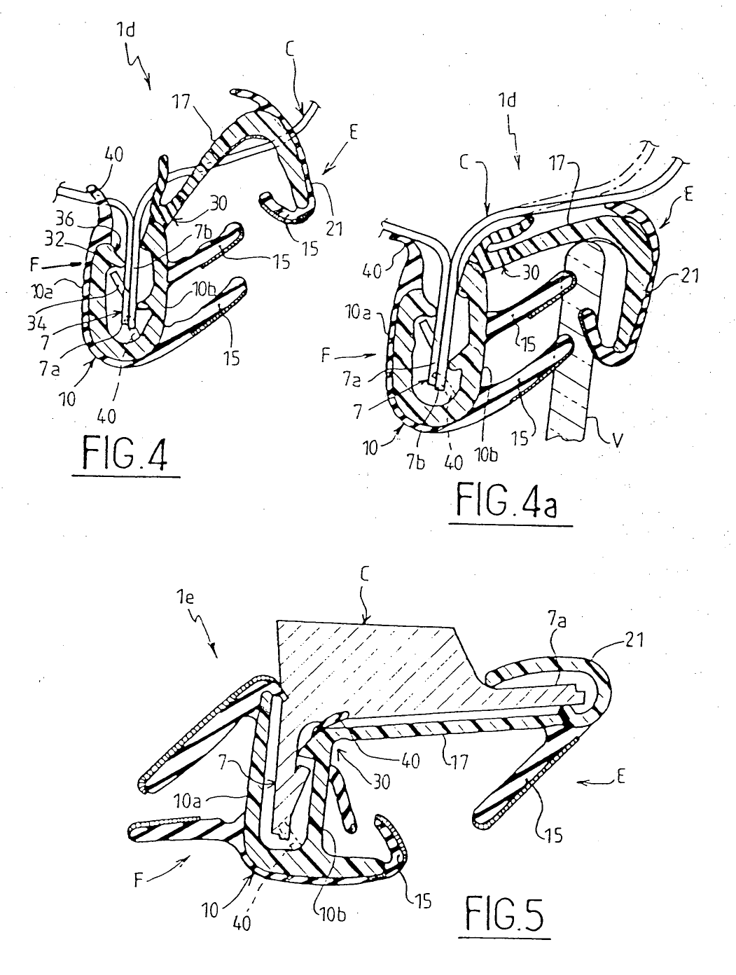

FIGS. 4, 4a, and 5 show a weatherstrip forming a slideway in two embodiments of the invention where elements that are common between these strips and the prior art strips of FIGS. 1 to 3 are given the same reference symbols.

The weatherstrip 1d is of the same type as that shown in FIG. 2, but without the presence of any reinforcing strength member 12 whether in the clip 10 or in the intermediate web 17 or in the end branch 21. The weatherstrip 1d therefore does not contain any reinforcing element of the metal strength member type or the like.

In general, the fixing portion F forming the clip 10 is made of a rigid thermoplastic material such as polypropylene. The portion E for supporting the sealing lips 15 may be made either out of the same material as the clip 10, or in a material having a bending modulus that is much smaller than that of the thermoplastic material used for the clip, e.g. a flexible thermoplastic.

In addition, a hinge 30 is provided between the fixing portion F and the portion E for supporting the sealing lips 15. This hinge 30 may be constituted by a link zone made of material that is more flexible than polypropylene, e.g. a thermoplastic elastomer (TPE) material.

Thus, the two portions F and E of the weatherstrip 1d are free to move independently of each other. FIG. 4 shows the weatherstrip 1d in a non-deformed position, whereas in FIG. 4a it is shown in the position that corresponds to the strip 1d being mounted in position on the flange 7.

In order to ensure that the clip 10 holds properly in the assembly direction of the weatherstrip and in order to oppose extraction or removal of the weatherstrip 1d once it has been mounted on the flange 7, a retaining abutment 32 projects into the inside of the clip 10 so as to come substantially into contact with a projection 34 on the flange 7. The retaining abutment 32 may be formed towards the end of the jaw 10a of the clip 10 in the form of a bead 36 which defines a shoulder forming the abutment 32. The projection 34 from the flange 7 may be formed, for example, by a barb of sheet metal, such as a crimping fold, or it may be a separate, fitted element, or may be in the form of a stamping such as a plunged boss for establishing a hard point.

In order to control the positioning of the chip 10 on the flange 7 as a function of metalwork clearances and in order to ensure that the assembly is properly stable, at least one clearance-accommodating lip 40 is provided. In the example of FIG. 4, the lip 40 is situated extending the jaw 10a of the clip 10 so as to come into contact with a zone of the door framework C that is situated close to the flange 7. In a variant, the lip 40 could be situated inside the clip 10 so as to come into contact with the flange 7.

The weatherstrip 1d may form the top segment or a vertical segment of a slideway.

The weatherstrip 1e constituting the second embodiment of the invention shown in FIG. 5 corresponds to the prior art strip shown in FIG. 3, but is likewise made out of rigid thermoplastic material such as polypropylene, thereby making it possible to omit the reinforcing strength member 12 both in the clip 10 and in the intermediate web 17. The strip 1e therefore does not include any reinforcing element.

Furthermore, a hinge 30 is likewise provided between the fixing portion F and the portion E supporting the sealing lips 15. This hinge 30 may be obtained merely by reducing wall thickness, for example, and it provides the same advantages as the hinge shown in FIG. 4.

The weatherstrip 1e also presents a retaining abutment 32 which co-operates with a projection 34 from the flange 7 so as to oppose extraction or removal of the weatherstrip 1e once it has been mounted on the flange 7, and it also presents a clearance-accommodating lip 40 situated at the end of jaw 10b of the clip 10 so as to come into contact with the door framework C in a zone situated at the root of the flange 7.

The weatherstrip 1e may advantageously form the top segment and/or a vertical segment of a slideway.

What is claimed is:

1. A weatherstrip forming a slideway for a motor vehicle window, the strip comprising at least a fixing portion in the form of a channel-section clip suitable for engaging on a flange of the frame of a window opening of the vehicle, and a support portion supporting sealing lips which are suitable for coming into sliding contact with a sliding window pane, the fixing portion being made from a rigid thermoplastic material without the presence of reinforcing means, and wherein a hinge is formed between the fixing portion and the portion supporting the sealing lips.

2. A weatherstrip according to claim 1, wherein the portion supporting the sealing lips is made of a thermoplastic material having a bending modulus that is much smaller than that of the thermoplastic material used for the fixing portion of the weatherstrip.

3. A weatherstrip according to claim 2, wherein the portion supporting the sealing lips is made of a flexible thermoplastic material.

4. A weatherstrip according to claim 1, wherein the hinge is obtained by reducing wall thickness.

5. A weatherstrip according to claim 1, wherein the hinge is made of a material that is more flexible than the material used for making the fixing portion and the sealing lip support portion.

6. A weatherstrip according to claim 5, wherein the hinge is made of a thermoplastic elastomer.

7. A weatherstrip according to claim 1, wherein the fixing portion and the portion supporting the sealing lips are made of polypropylene.

8. A weatherstrip according to claim 1, further comprising at least one retaining abutment for opposing removal of the clip when mounted on the flange.

9. A weatherstrip according to claim 8, wherein the retaining abutment is situated on one of the two jaws of the clip, extending towards the inside of the clip and suitable for coming into contact with a projection from the flange.

10. A weatherstrip according to claim 1, wherein the flange supporting the clip is constituted by at least one piece of sheet metal, and wherein the strip also includes at least one lip for controlling the positioning of the clip on the flange as a function of the sheet metal clearances thereof, and wherein the clearance-accommodating lip is situated at the end of one of the jaws or inside the clip.

11. A weatherstrip according to claim 1, forming a single-flange type slideway.

12. A weatherstrip according to claim 1, forming a hidden frame type slideway.
